(19) United States
(12) Patent Application Publication
(10) Pub. No.: US 2009/0006742 A1
(43) Pub. Date: Jan. 1, 2009

(54) Method and apparatus improving performance of a digital memory array device

(76) Inventors: Min Huang, Cupertino, CA (US); Chris Wilkerson, Portland, OR (US); Nam Sung Kim, Portland, OR (US); Moinuddin K. Qureshi, Austin, TX (US)

Correspondence Address: LAW OFFICE OF DONALD D. MONDUL;c/o INTELLEVATE, P.O. BOX 52050, MINNEAPOLIS, MN, 55402, US

(21) Appl. No.: 11/823,358

(22) Filed: Jun. 27, 2007

(51) Int. Cl. G06F 12/00

(52) U.S. Cl. 711/114

(57) ABSTRACT

A method for improving performance of a digital memory array device including a plurality of memory cells; each respective memory cell storing a first digital value and a second digital value being an inverse of the first digital value; storing of the first and second digital values being controlled by a first digital signal effecting selection of a specified memory cell for storing; includes: (a) determining an extant value relating to the first digital signal; (b) if the extant value has a first value, effecting a bit flip operation in the specified memory cell to invert values of at least one of the stored first digital and the second digital values; (c) if the extant value does not have the first value, foregoing the bit flip operation in the specified memory cell.

### BACKGROUND

As known by those skilled in the art of memory cell design, memory cell arrays may be embodied in symmetrical arrays or asymmetrical arrays. Symmetrical arrays are substantially symmetrically configured with respect to bit lines from which output data may be read by a read circuit, such as a sense array. Asymmetrical arrays may employ differently configured transistor devices in association with differing portions of an array in order to accommodate some anticipated operational condition in the operational environment in which the array may be employed.

With effects of aging and other operational realities, even symmetrically configured arrays may operate asymmetrically. By way of example and not by way of limitation, one bit line of a pair of bit lines in a memory array may experience more activities such as precharge, read operation (e.g., as by operating a sense amplifier) and write operation. Such asymmetric operational activity may result in transistors associated with the more active bit line operation being more susceptible to stress, aging or other causes of operational degradation. As device aging proceeds, the reliability of the memory array may degrade.

Studies have ascertained that stored data may be comprised of a greater proportion of “0” bit values than of “1” bit values. Some estimates may indicate that approximately 75% of content a data cache may be “0” bit values data cache, and approximately 64% of content an instruction data cache may be “0” bit values. Impacts from asymmetric or biased memory cell contents may further exacerbate degradation of a memory array device.

As may be known by those skilled in the art of memory array design, bit lines in such an array may be precharged to an equalized value such as, by way of example and not by way of limitation a “1” value before reading the array, so the differential values in differential bit lines can be developed during a read operation. This may be so because many memory cell designs are capable only of pulling a bit line to a certain value, such as a “0”, rather than raising a bit line to an opposite value, such as a “1”. The purpose of a precharge operation is to equalize the bit lines of the memory array to a given value so that the difference can be developed during a read operation. A precharge operation may effect precharging bit lines to either a “1” value or to a “0” value. As a consequence, by way of example and not by way of limitation, a “0” value may perform an actual write operation in a memory array apparatus. When most of cache content is “0”, a half of the memory array device may be active, while the other half may mostly stay at a precharged value (e.g., “1”). Even when a memory array physical structure is symmetrical, the contents stored in the array and the activities performed by the array may be asymmetrical.

Such asymmetrical characteristics associated with a memory array and other conditions and activities associated with a memory array such as, by way of example and not by way of limitation, word line leakage, bit line leakage, erratic high and low supply voltage signals, oxide degradation and Negative Bias Temperature Instability (NBTI) may further contribute to aging of memory cells and resultant instability of operation of a memory array apparatus of which the memory cells are a part.

There is a need for a method and apparatus for reducing aging and instability of a memory array device.

In particular there is a need for a method and apparatus for reducing aging and instability of a memory array device pseudo-randomly without requiring significant additional hardware for implementation.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an embodiment of an apparatus for improving performance of a digital memory array.

FIG. 2 illustrates details of a representative embodiment of an apparatus for improving performance of a digital memory array.

FIG. 3 is a flow diagram illustrating an embodiment of the method of the present invention.

It will be appreciated that for simplicity and clarity of illustration, elements illustrated in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details may be set forth in order to provide a thorough understanding of embodiments of the invention. However, it may be understood by those skilled in the art that embodiments of the invention may be practiced without these specific details. In other instances, well-known methods, procedures, components and circuits may not be described in detail so as not to obscure embodiments of the invention.

Unless specifically stated otherwise, as apparent from the following discussions, it is appreciated that throughout the specification discussions utilizing terms such as “processing,” “computing,” “calculating,” “determining,” or the like, may refer to the action or processes of a computer or computing system, or similar electronic computing device, that manipulate or transform data represented as physical, such as electronic, quantities within the computing system's registers or memories into other data similarly represented as physical quantities within the computing system's memories, registers or other such information storage, transmission or display devices.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein may not be inherently related to any particular computing device or other apparatus. Various general purpose systems may be used with programs in accordance with the teachings herein, or it may prove convenient to construct a more specialized apparatus to perform the desired method. The desired structure for a variety of these systems may appear from the description below. In addition, embodiments of the present invention may not be described with reference to any particular programming language. It may be appreciated that a variety of programming languages may be used to implement the teachings of the invention as described herein. In addition, it may be understood that operations, capabilities, and features described herein may be implemented with any combination of hardware (discrete or integrated circuits) and software.

The terms “coupled” and “connected”, along with their derivatives, may be used. It may be understood that these terms are not intended as synonyms for each other. Rather, in particular embodiments, “connected” may be used to indicate that two or more elements are in direct physical or electrical contact with each other. “Coupled” may be used to indicate that two or more elements are in either direct or indirect (with other intervening elements between them) physical or electrical contact with each other, or that the two or more elements co-operate or interact with each other (e.g. as in a cause and effect relationship).

It may be understood that embodiments of the present invention may be used in a variety of applications. Although embodiments of the invention may not be limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), wireless local area networks (WLAN), personal area networks (PAN, and the like).

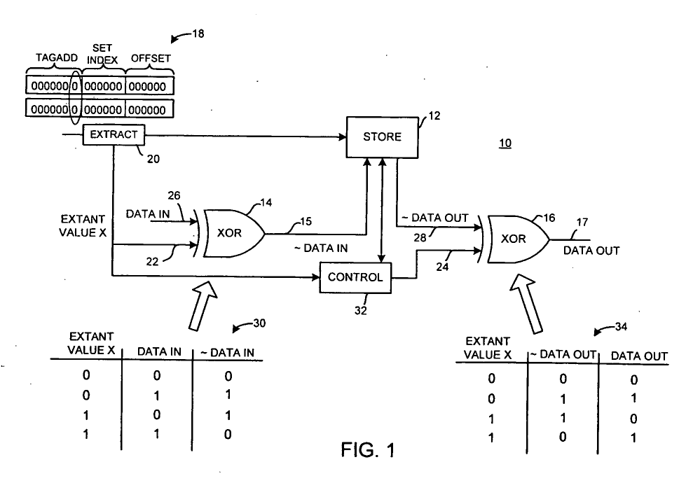

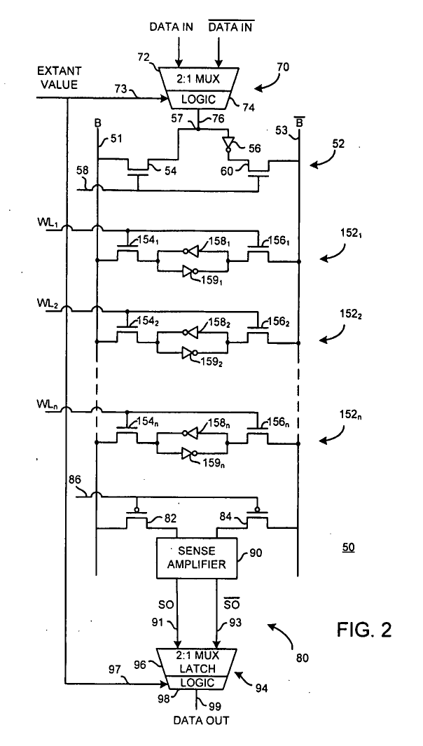

FIG. 1 illustrates an embodiment of an apparatus for improving performance of a digital memory array. In FIG. 1, a digital memory array device may include a data store 12, a writing or storing logic unit 14 and a reading logic unit 16. An address signal 18 may be provided to data store 12 for identifying a specified memory cell (not shown in detail in FIG. 1; see FIG. 2) in which an extant data element may be stored or written. Address signal 18 may, by way of example and not by way of limitation, include first specified bits identifying a tag address TAGADD portion of an address, second specified bits identifying a set index portion of an address and third specified bits identifying an offset portion of an address.

An extracting unit 20 may treat address signal 18 to extract or otherwise identify and copy or obtain an extant value X. By way of example and not by way of limitation, extant value X may be related to a least significant bit (LSB) of a tag address TAGADD portion of an address, as illustrated in FIG. 1. Extant value X may be applied to a first input locus 22 of writing logic unit 14 and may be applied to a first input locus 24 of reading logic unit 16. Extracting or otherwise obtaining extant value X from address signal 18 is exemplary only. An appropriate extant value X may be obtained from any signal relating to operation of digital memory array device 10.

Data intended for writing into storage in data store 12 may be represented in a signal DATA IN provided to a second input locus 26 of writing logic unit 14. Writing logic unit 14 may employ extant value X presented at input locus 22 and signal DATA IN presented at input locus 26 to determine whether to perform a bit flip operation when storing bit information contained in signal DATA IN in data store 12.

By way of example and not by way of limitation, writing logic unit 14 may be embodied in an XOR logic gate executing logical operations according to a logic table 30. An output signal ˜DATA IN from writing logic unit 14 may be presented at an output locus 15 of writing logic unit 14 to represent interim data as it may be stored in data store 12. One may observe that writing logic unit 14 may operate to invert data in arriving signal DATA IN at input locus 26 for presentation as an interim data signal ˜DATA IN at output locus 15 for storage in data store 12 whenever extant value X, has a first value “1”. Whenever extant value X has a second value “0”, data in arriving signal DATA IN at input locus 26 for presentation as interim data signal ˜DATA IN at output locus 15 for storage in data store 12 may not be inverted.

When data is read from data store 12, data intended for reading from data store 12 may be represented in an interim data out signal ˜DATA OUT provided to a second input locus 28 of reading logic unit 16.

A control unit 32 may cooperate with data store 12, or may otherwise be affected by digital memory array device 10, to assure that interim data out signal ˜DATA OUT provided from data store 12 to reading logic unit 16 may be accompanied by the same extant value X that accompanied storing the presented interim data signal ˜DATA IN when provided for storing in data store 12 by writing logic unit 14.

By way of example and not by way of limitation, reading logic unit 16 may be embodied in an XOR logic gate executing logical operations according to logic table 34. An output signal DATA OUT from reading logic unit 16 may result from logical combination of interim data out signal ˜DATA OUT as it may be stored in data store 12 and the extant value X that accompanied storing the presented interim data out signal ˜DATA OUT when it was interim data in signal ˜DATA IN provided for storing in data store 12 by writing logic unit 12. One may observe that reading logic unit 16 may operate to invert data in interim data out signal ˜DATA OUT at input locus 28 for presentation as data out signal DATA OUT at an output locus 17 of reading logic unit 16 whenever extant value X has a first value “1”. Whenever extant value X, provided at input locus 24 of reading logic unit 16, has a second value “0”, data in interim data out signal ˜DATA OUT at input locus 28 for presentation as data out signal DATA OUT at output locus 17 may not be inverted. As a result data out signal DATA OUT presented at output locus 17 may be uninverted with respect to input data signal DATA IN provided at input locus 26.

FIG. 2 illustrates details of a representative embodiment of an apparatus for improving performance of a digital memory array. In FIG. 2, a digital memory array device 50 may include memory cells 152₁, 152₂, 152ₙ arrayed between a bit line 51 presenting a bit B and an inverse bit line 53 presenting an inverse bit B̅ (indicating “NOT B”). The indicator “n” may be employed to signify that there can be any number of memory cells in digital memory array device 50. The inclusion of three memory cells 152₁, 152₂, 152ₙ in FIG. 2 is illustrative only and does not constitute any limitation regarding the number of memory cells that may be included in the digital memory array device of embodiments of the present invention.

Memory cell 152₁ may include an N-channel Metal Oxide Semiconductor (NMOS) transistor 154₁ coupled with bit line 51, an NMOS transistor 156₁ coupled with inverse bit line 53, and oppositely oriented inverter units 158₁, 159₁ coupled in parallel between NMOS transistors 154₁, 156₁. NMOS transistors 154₁, 156₁ are coupled for gating operation in response to gating signals presented on a memory cell select word line WL₁.

Memory cell 152₂ may include an NMOS transistor 154₂ coupled with bit line 51, an NMOS transistor 156₂ coupled with inverse bit line 53, and oppositely, oriented inverter units 158₂, 159₂ coupled in parallel between NMOS transistors 154₂, 156₂. NMOS transistors 154₂, 156₂ are coupled for gating operation in response to gating signals presented on a memory cell select word line WL₂.

Memory cell 152ₙ may include an NMOS transistor 154ₙ coupled with bit line 51, an NMOS transistor 156ₙ coupled with inverse bit line 53, and oppositely oriented inverter units 158ₙ, 159ₙ coupled in parallel between NMOS transistors 154ₙ, 156ₙ. NMOS transistors 154ₙ, 156ₙ are coupled for gating operation in response to gating signals presented on a memory cell select word line WLₙ.

Digital memory array device 50 may also include a writing unit 70 and a reading unit 80. Writing unit 70 may include a multiplexing unit such as, by way of example and not by way of limitation, a 2:1 multiplexing unit 72 receiving two data input signals DATA IN, D̅A̅T̅A̅I̅N̅ (indicating “NOT DATA IN”). Input signal D̅A̅T̅A̅I̅N̅ may be a substantially inverse or oppositely oriented mirror image of input signal DATA IN. Coupled with multiplexing unit 72 may be a logic unit 74. Logic unit 74 may cooperate may receive an EXTANT VALUE at an input locus 73. Multiplexing unit 72 and logic unit 74 may cooperate to present a control signal at a WRITE line 76.

Writing unit 70 may also include a write enable unit 52 coupled between bit lines 51, 53. Write enable unit 52 may receive the control signal presented at WRITE line 76 at a circuit locus 57.

Write enable unit 52 may include an N-channel Metal Oxide Semiconductor (NMOS) transistor 54 coupled between bit line 51 and an inverter unit 56. NMOS transistor 54 may be configured and coupled for gating operation in response to gating signals presented on a WRITE ENABLE/SELECT line 58. Write enable unit 52 may further include an N-channel Metal Oxide Semiconductor (NMOS) transistor 60 coupled between inverter unit 56 and bit line 53. NMOS transistor 60 may be configured and coupled for gating operation in response to gating signals presented on WRITE ENABLE/SELECT line 58.

WRITE line 76 may operate with write enable unit 52 in cooperation with selected signaling on respective memory cell select word lines WL₁, WL₂, WLₙ to effect writing of data to at least one selected memory cell 152₁, 152₂, 152ₙ according to address information accompanying data signals DATA IN, D̅A̅T̅A̅I̅N̅. Addressing of storage or writing of data within memory array device 50 is not shown in detail in FIG. 2. Signals presented at input locus 73, at WRITE ENABLE/SELECT line 58, and at memory cell select word lines WL₁, WL₂, WLₙ may be received, by way of example and not by way of limitation, from extracting unit 20 or control unit 20 (FIG. 1). Such details of configuration and operation may be familiar to those skilled in the art of memory array device design. Multiplexing unit 72 and logic unit 74 may also cooperate to selectively invert data bits stored in memory units 152₁, 152₂, 152ₙ according to value of EXTANT VALUE received at input locus 73 of logic unit 74, generally as described in connection with FIG. 1 above.

Reading unit 80 may include a sensing unit 90 and a signal treating unit 94. Sensing unit 90 may include P-channel Metal Oxide Semiconductor (PMOS) transistors 82, 84. PMOS transistor 82 may be coupled between bit line 51 and sensing unit 90. PMOS transistor 82 may be configured and coupled for gating operation in response to gating signals presented on a READ ENABLE/SELECT line 86 from a gating signal unit (not shown in FIG. 2).

Sensing unit 90 may cooperate with selected signaling on respective memory cell select word lines WL₁, WL₂, WLₙ to effect reading of data from at least one selected memory cell 152₁, 152₂, 152ₙ. Addressing for reading of data within memory array device 50 is not shown in detail in FIG. 2. Signals presented at READ ENABLE/SELECT line 86 may be received, by way of example and not by way of limitation, from extracting unit 20 or control unit 20 (FIG. 1). Details of gating signal origins and operation may be known to those skilled in the art of memory array design. PMOS transistor 84 may be coupled between sensing unit 90 and bit line 53. PMOS transistor 84 may be configured and coupled for gating operation in response to gating signals presented on READ ENABLE/SELECT line 86.

Sensing unit 90 may be embodied in, by way of example and not by way of limitation, a sense amplifier coupled and configured for receiving input signals from PMOS transistors 82, 84. Sense amplifier 90 may present a sensed output signal SO at a first output locus 91 and may present a sensed output signal S̅O̅ (indicating “NOT SO”) at a second output locus 93. Output signal S̅O̅ may be a substantially inverse or oppositely oriented mirror image of output signal SO.

Signal treating unit 94 a multiplexing unit such as, by way of example and not by way of limitation, a 2:1 multiplexing unit 96 coupled with output loci 91, 93 and configured for receiving signals SO, S̅O̅. Coupled with multiplexing unit 96 may be a logic unit 98. Logic unit 98 may receive an EXTANT VALUE at an input locus 97. Multiplexing unit 96 and logic unit 98 may cooperate to present an output signal DATA OUT at an output locus 99.

Logic units 74, 94 may cooperate to assure that selectively inverted data bits stored in at least one selected memory cell 152₁, 152₂, 152ₙ according to value of EXTANT VALUE received at input locus 73 of logic unit 74 may be accompanied by the same EXTANT VALUE when presented at output locus 99 by treating unit 94. By such employment of the same EXTANT VALUE, treating unit 94 may assure that data bits inverted when stored according to the EXTANT VALUE present at input locus 73 may be reverse-inverted when presented as bits of signal DATA OUT at output locus 99 appropriately to assure that signal DATA OUT accurately represents signal DATA IN.

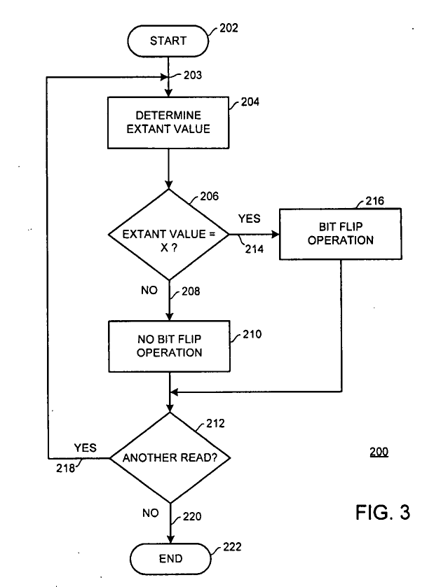

FIG. 3 is a flow diagram illustrating an embodiment of the method of the present invention. In FIG. 3, a method 200 for improving performance of a digital memory array device begins at a START locus 202. The memory array device may include a plurality of memory cells. Each respective memory cell of the plurality of memory cells may store a first digital value and a second digital value. The second digital value may be an inverse of the first digital value. Operation of the memory array device for storing the first and second digital values in each the respective memory cell may be controlled by at least one first digital signal. The at least one first digital signal may effect selection of a specified memory cell of the plurality of memory cells for storing the first and second digital values. Method 200 may continue with determining at least one extant value relating to the at least one first digital signal, as indicated by a block 204.

Method 200 may continue by posing a query whether the at lest one extant value has a first value, as indicated by a query block 206. If the at least one extant value has a first value, method 200 may proceed from query block 206 via a YES response line 214 and effect a bit flip operation in the specified memory cell, as indicated by a block 216. The bit flip operation may effect inverting of values of at least one of the first digital value and the second digital value stored in the specified memory cell.

If the at least one extant value does not have the first value, method 200 may proceed from query block 206 via a NO response line 208 and may forego effecting the bit flip operation in the specified memory cell, as indicated by a block 210.

Method 200 may continue by posing a query whether another read operation is to be performed, as indicated by a query block 212. If another read operation is to be performed, method 200 may proceed from query block 212 via a YES response line 218 to a locus 203, and may thereafter repeat steps indicated by blocks 204, 206, 210, 216, 212 as appropriate. If another read operation is not to be performed, method 200 may proceed from query block 212 via a NO response line 220 and method 200 may terminate, as indicated by an END locus 222.

If bit line values B, B̅ on bit lines 51, 53 may be randomly assigned “0” and “1” values according to a bit flip operation, then impact of asymmetrical operation, aging, NBTI, un-balanced leakage and other operating and configuration anomalies may be reduced. Since the B, B̅ nodes in a memory array device may co-exist, pseudo-randomly flipping B, B̅ values may reduce adverse effects upon the memory array device. A result may be that the biased cache contents stored in memory cells in a memory array device may not cause biased values at internal nodes of the memory array device nor generate biased activities along bit lines B, B̅.

There may be many signals or other indicating parameters that may be employed to effect pseudo-randomly flipping contents of a memory array as described here. A representative implementation described in this disclosure employs the least significant bit of a tag address signal TAGADD to flip bit contained in cache lines, or bit lines, of a memory array device. The inventors have observed that the probability of a least significant bit of a tag address signal TAGADD being set to 1 is nearly 50%. Therefore, the probability of an inverted value being allocated into a given bit line is about the same as the probability of a non-inverted line being allocated to a given bit line. As a result, data bias may be substantially reduced.

While certain features of the invention have been illustrated and described herein, many modifications, substitutions, changes, and equivalents may now occur to those skilled in the art. It may, therefore, be understood that the appended claims are intended to cover all such modifications and changes as fall within the true spirit of embodiments of the invention.

1. A method comprising:
(a) determining at least one extant value relating to at least one first digital signal in a digital array memory device; said at least one first digital signal effecting selection of a specified memory cell of a plurality of memory cells in said memory device to store a first digital value and a second digital value; said second digital value being an inverse of said first digital value;
(b) if said at least one extant value satisfies a first predetermined condition, effecting a bit flip operation with data to be stored in said specified memory cell; said bit flip operation effecting inverting of values of at least one of said first digital value and said second digital value to be stored in said specified memory cell;
(c) if said at least one extant value does not satisfy said a first predetermined condition, foregoing effecting said bit flip operation with data to be stored in said specified memory cell.

2. A method as recited in claim 1 wherein operation of said memory array device to read said first and second digital values in each said respective memory cell is controlled by at least one second digital signal; said at least one second digital signal effecting selection of a particular memory cell of said plurality of memory cells to read; said at least one second digital signal controlling presenting at least one of a first read value and a second read value from said particular memory cell to an output unit; said output unit employing said at least one extant value for treating said at least one of a first read value and a second read value for presenting an output read value from said particular memory cell; the method further comprising:
(d) if said at least one extant value satisfies said first predetermined condition, effecting said bit flip operation with said at least one of a first read value and a second read value in effecting said treating;
(e) if said at least one extant value does not satisfy said first predetermined condition, foregoing effecting said bit flip operation in effecting said treating.

3. A method as recited in claim 1 wherein said at least one extant value comprises a predetermined bit of a selected digital signal of said at least one first digital signal.

4. A method as recited in claim 1 wherein said at least one first digital signal comprises an address signal identifying said specified memory cell.

5. A method as recited in claim 2 wherein said at least one extant value comprises a predetermined bit of a selected digital signal of said at least one first digital signal.

6. A method as recited in claim 2 wherein said selected digital signal comprises an address signal identifying said specified memory cell.

7. A method as recited in claim 5 wherein said selected digital signal comprises an address signal identifying said specified memory cell.

8. An apparatus comprising:
a first logic unit coupled with a memory array device; said memory array device including a plurality of memory cells; each respective memory cell of said plurality of memory cells being configured to store a first digital value and a second digital value; said second digital value being an inverse of said first digital value; at least one first digital signal being employed to control operation of said memory array device to store said first and second digital values in each said respective memory cell; said at least one first digital signal effecting cell selection of a specified memory cell of said plurality of memory cells to store said first and second digital values;
said first logic unit being configured to receive said first digital signal and to employ said first digital signal to effect said cell selection; said first logic unit being configured to determine at least one extant value relating to said at least one first digital signal; said logic unit effecting a bit flip operation with data to be stored in said specified memory cell if said at least one extant value satisfies a first predetermined condition; said bit flip operation being configured to invert values of at least one of said first digital value and said second digital value to be stored in said specified memory cell; said first logic unit foregoing effecting said bit flip operation in said specified memory cell if said at least one extant value does not satisfy said first predetermined condition.

9. An apparatus as recited in claim 8 wherein the apparatus further comprises: a second logic unit coupled with said memory array device and an output unit coupled with said second logic unit; said second logic unit being configured to receive at least one second digital signal for effecting selection of a particular memory cell of said plurality of memory cells to read said first and second digital values in said particular memory cell; said at least one second digital signal being configured to control presenting at least one of a first read value and a second read value from said particular memory cell to said output unit; said output unit being configured to employ said at least one extant value to treat said at least one of a first read value and a second read value to present an output read value from said particular memory cell at an output locus coupled with said output unit; if said at least one extant value satisfies said first predetermined condition, at least one of said output unit and said second logic unit effects said bit flip operation with said at least one of a first read value and a second read value in effecting said treating; if said at least one extant value does not satisfy said first predetermined condition, at least one of said output unit and said second logic unit foregoes effecting said bit flip operation in effecting said treating.

10. An apparatus as recited in claim 8 wherein said at least one extant value comprises a predetermined bit of a selected digital signal of said at least one first digital signal.

11. An apparatus as recited in claim 8 wherein said at least one first digital signal comprises an address signal to identify said specified memory cell.

12. An apparatus as recited in claim 9 wherein said at least one extant value comprises a predetermined bit of a selected digital signal of said at least one first digital signal.

13. An apparatus as recited in claim 9 wherein said selected digital signal comprises an address signal to identify said specified memory cell.

14. An apparatus as recited in claim 12 wherein said selected digital signal comprises an address signal to identify said specified memory cell.
